(19) United States
(12) Patent Application Publication
(10) Pub. No.: US 2024/0055164 A1
(43) Pub. Date: Feb. 15, 2024

(54) INTERFACE MATERIALS FOR COMPOSITE MAGNETS

(71) Applicant: FORD GLOBAL TECHNOLOGIES, LLC, Dearborn, MI (US)

(72) Inventor: Chuanbing Rong, Canton, MI (US)

(21) Appl. No.: 17/886,937

(22) Filed: Aug. 12, 2022

(51) Int. Cl. H01F 1/057

(52) U.S. Cl. CPC H01F 1/0578; H01F 1/0579

(57) ABSTRACT

Composite magnets such as for electrical machines in vehicles are disclosed. The composite magnets have an interface phase that is different than the magnetically-hard phase and the magnetically-soft phase to ease the transition or create a gradual transition from between the hard and soft phases of the composite magnet. The addition of, for example, an interface layer maintains or enhances performance of the magnetic properties even with higher grain sizes such as beyond the nanoscale level.

### TECHNICAL FIELD

The present disclosure relates to permanent magnets and more specifically, the disclosure relates to composite magnets having an interface material.

### BACKGROUND

Magnets pervade many technologies of modern life. Permanent magnets such as rare earth magnets (e.g., Nd—Fe—B) are widely used in electric machines and may be used in modern vehicles including electric vehicles and hybrid electric vehicles. For example, electric machines may include motors such as traction motors.

### SUMMARY

A composite magnet having permanent magnet regions, non-permanent (i.e., temporary) magnet regions, and interface regions therebetween is disclosed. For example, the composite magnet may have a plurality of permanent magnet regions such as permanent magnet layers, a plurality of non-permanent magnet regions such as non-permanent magnet layers, and a plurality of interface regions disposed between the permanent and non-permanent regions. The permanent magnet regions, non-permanent magnet regions, and interface regions may all have a different composition from each other. For example, each region may have a different composition than the adjacent region(s).

Another composite magnet having a magnetically-hard portion, a magnetically-soft portion, and an interface portion disposed between the magnetically-hard and magnetically-soft portions is disclosed. In a refinement, the composition of the magnetically-hard portion, the magnetically-soft portion, and the interface portion is different. For example, each may have a different chemical structure.

A method of manufacturing a composite magnet is also disclosed. The method includes disposing an interface layer on a magnetically-soft layer, disposing a magnetically hard layer on the interface layer opposite the magnetically-soft layer, and joining the layers together to form a composite magnet.

### BRIEF DESCRIPTION OF THE DRAWINGS

FIG. 1 is perspective view of an embodiment of a composite magnet.

FIG. 2 is a magnetic flux density with respect to magnetizing force (BH plot) depicting the results of conventional composite magnets and the composite magnets disclosed herein.

FIG. 3 is a BH plot depicting a conventional composite and other embodiments of composites described herein.

FIG. 4 is a flow chart depicting a method of making a magnet.

FIG. 5 is a cross-sectional view of another embodiment of a composite magnet.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Unless expressly stated to the contrary, percent, “parts of,” and ratio values are by weight. The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

This disclosure is not limited to the specific embodiments and methods described below, as specific components and/or conditions may vary. Furthermore, the terminology used herein is used only for the purpose of describing particular embodiments and is not intended to be limiting in any way.

As used in the specification and the appended claims, the singular form “a,” “an,” and “the” comprise plural referents unless the context clearly indicates otherwise. For example, reference to a component in the singular is intended to comprise a plurality of components.

The term “substantially” or “generally” may be used herein to describe disclosed or claimed embodiments. The term “substantially” may modify a value or relative characteristic disclosed or claimed in the present disclosure. In such instances, “substantially” may signify that the value or relative characteristic it modifies is within ±0%, 0.1%, 0.5%, 1%, 2%, 3%, 4%, 5% or 10% of the value or relative characteristic.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

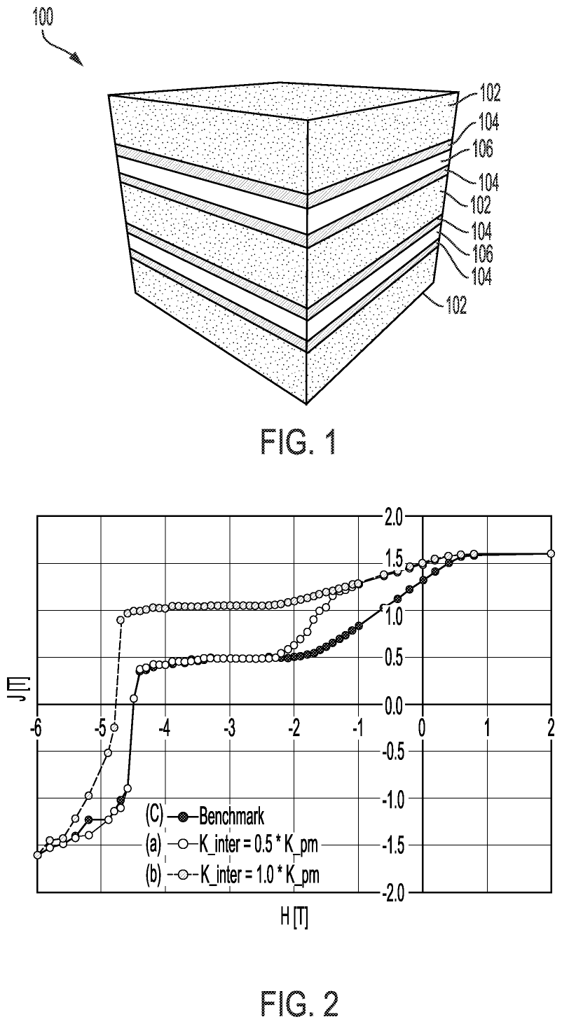

Referring to FIG. 1, a composite magnet 100 having a first plurality of first regions 102, a second plurality of second regions 104, and a third plurality of third regions 106 is disclosed. In a refinement, the first regions may be magnetically-hard portions 102, the second regions may be interface/transition portions 104 and the third regions may be magnetically-soft portions 106. In a refinement, a second region of the second plurality may be disposed between each of the first and third regions. In other words, an interface/transition material may be disposed between the magnetically-hard and magnetically-soft regions. In a variation, the second regions (i.e., interface/transition material may only be disposed on one side of a first (magnetically hard) region and/or a second (magnetically-soft) region. For example, the composite magnetic may be comprised of follow the sequence of a first magnetically-hard layer, a first interface layer, and a first magnetically-soft layer. This sequence may be repeated as necessary such that a second magnetically-hard layer is disposed adjacent the first magnetically-soft layer opposite the first interface layer followed by a second interface layer and a second magnetically-soft layer as shown in FIG. 5

Magnetically-hard portions 102 may maintain their magnetic properties after being magnetized, i.e., are difficult to demagnetize whereas magnetically-soft portions 106 may not maintain their magnetic properties after being magnetized, i.e., are easy demagnetized. In one or more embodiments, the magnetically-hard portions 102 may be permanent magnet portions (e.g., Nd—Fe—B and/or SmCo) and the magnetically-soft portions 106 may be non-permanent magnet portions (e.g., Fe and/or FeCo). In a variation, the magnetically-hard portions 102 may have a high coercivity (e.g., at least 700 kA/m, or more preferably at least 800 kA/m, or even more preferably at least 850 kA/m), and may have lower saturation magnetization, whereas magnetically-soft portions 106 may have a low coercivity (e.g., no more than 50 kA/m, or more preferably no more than 30 kA/m, or even more preferably no more than 20 kA/m), and may have higher saturation magnetization. In a variation, the magnetically-hard region may surprisingly have a greater thickness than conventional nano-scale composite magnets without sacrificing performance or even while having better performance because of the addition of the interface/transition region. For example, the magnetically hard region may have a thickness of least 1 μm, or more preferably at least 500 nm, or even more preferably at least 250 nm, or still even more preferably at least 100 nm.

Composite materials made of magnetically-hard and magnetically-soft materials are discussed in US20210158999 identified by Ser. No. 16/690,237 and filed on Nov. 21, 2019, which is hereby incorporated by reference in its entirety. Non-permanent magnets may refer to magnets that lose their magnetic properties or demagnetize easily. For example, under ambient conditions (i.e., in the absence of an electromagnetic field), non-permanent, i.e., temporary magnets, may lose their magnetization within 1 millisecond, 1 second, 30 seconds, 30 minutes, 1 hour, or 12 hours. Alternatively, they may become demagnetized under mechanical shear such as hammering, or during heating such as at temperatures of 80° C., or 100° C., or at 250° C.

The interface portions 104 may include an interface/transition material such that they create a gradient via the first, second, and third regions. The interface portions 104 are disposed between each magnetically-hard region and each magnetically-soft region such that the interface/transition material ease the transition from the magnetically-hard material to the magnetically-soft material, i.e., the transition between the hard and soft regions is more gradual by the addition of the interface/transition region. For example, the first (i.e., magnetically-hard) region may have a higher coercivity than the second (i.e., interface) region which may have a higher coercivity than the third (i.e., magnetically-soft) region. Alternatively, or in combination the first (i.e., magnetically-hard) region may have a lower saturation magnetization than the second (i.e., interface) region which may have a lower saturation magnetization than the third (i.e., magnetically-soft) region. In other words, the saturation magnetization of the second (i.e., interface) region may be between the first and third (i.e., magnetically-hard and magnetically-soft) regions.

In a variation, the interface portion 104 may include a lower grade permanent magnet and/or a semi-hard magnetic material. In other words, the coercivity of the second (interface/transition) region/portion is between the coercivities of the first (magnetically-hard) and third (magnetically-soft) regions/portions. In a refinement, the second (i.e., interface) region may have a coercivity of 5 to 1500 or more preferably 5 to 950 kA/m, or more even preferably 20 to 800 kA/m, or still even more preferably 50 to 700 kA/m. For example, the interface/transition material may include a lower grade permanent magnet material, Al—Ni—Co, Fe—N, Mn—Al, Mn—Al—C, and/or Mn—Bi. In a variation, the magnetically-hard material, magnetically-soft material, and/or interface material, may be different such as having chemically different compositions. A lower grade permanent magnet may refer to a magnet having a lower maximum energy product such as measured in kilojoules per cubic meter (KJ/m 3) or mega-gauss-oersted (MGOe) and/or a magnet having a lower coercivity.

In a refinement, the first (i.e., magnetically-hard) regions may have a saturation magnetization of no more than 180 emu/g, or more preferably no more than 100 emu/g, or even more preferably no more than 75 emu/g. The second (i.e., interface) regions may have a saturation magnetization of 60 to 200 emu/g or more preferably 100 to 180 emu/g, or even more preferably 160 to 120 emu/g and the third (magnetically-soft) regions may have a saturation of at least 180 emu/g, or more preferably at least 200 emu/g, or even more preferably at least 210 emu/g.

In a variation, the regions/portions may be an arrangement of layers. For example, a plurality of magnetically-hard layers, a plurality of interface layers, and a plurality of magnetically-soft layers may be arranged such that each magnetically-hard layer and each magnetically-soft layer are separated by an interface layer. As the grain size is not limited to a nanoscale level (for example the average grain size may be at least 1 μm or more preferably at least 500 nm, or even more preferably at least 250, or still even more preferably at least 100 nm), the layers may be at least 1 μm, or more preferably at least 0.5 μm, or even more preferably at least 0.25 μm. In other words, the thickness of any layer may be 0.1 to 2500 μm, or more preferably 0.5 to 1000 μm, or even more 1 to 500 μm, or still more preferably 3 to 250 μm. In a refinement, the magnetically-soft layer may have a thickness that is 10 to 60%, or more preferably 15 to 50%, or even more preferably 25 to 33% the thickness of the magnetically-hard layer, and the interface layer may have a thickness that is 10 to 70% or more preferably 15 to 60%, or even more preferably 25 to 50% the thickness of the magnetically-soft layer (i.e., the magnetically-soft layer has a thickness that is 100 to 700%, or more preferably 150 to 500%, or even more preferably 200 to 400% than the thickness of the interface layer and the magnetically-hard layer has a thickness that is 100-700%, or more preferably 150 to 500%, or even more preferably 200 to 400% than the thickness of the magnetically-soft layer. The combination of an interface/transition layer (i.e., the three or more layer arrangement) will perform as well as, if not better than, the two layer arrangement and has grain sizes that make manufacturing easier and reduce expense.

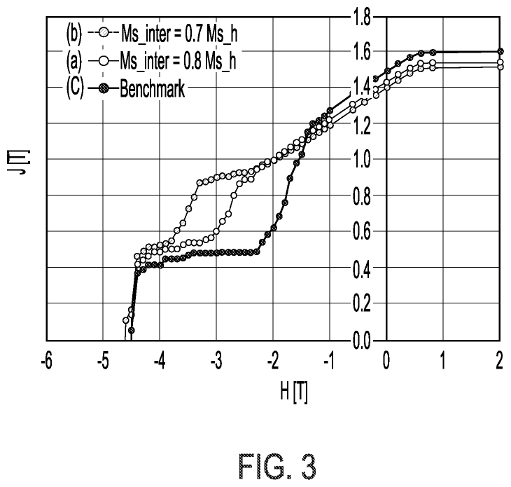

For example, FIG. 2 illustrates a normalized BH plot depicting composite magnets as described herein: (a) a composite magnet with an interface material having an anisotropy constant that is 50% of the permanent magnet material (i.e., a lower grade permanent magnet). The plot also depicts two controls including (b) a composite of a magnetically-hard material and a magnetically-soft material with the interface layers being substituted with additional permanent magnet layers, (c) a composite of a magnetically-hard material and a magnetically-soft material with the interface material being substituted for a magnetically-soft material. In yet another example, FIG. 3 depicts a BH plot using (c) a control with the interface layers substituted with additional permanent magnet layers, and two composite as described herein: (a) a composite having an interface material with a saturated magnetization that is 80% of the permanent magnet and (b) a composite having an interface material with a saturated magnetization that is 70% of the permanent magnet. As shown in FIGS. 2-3, the addition of an interface material provides enhanced magnetic properties compared to conventional composite magnets. For example, the composites using an interface material may have superior coercivity with only minimal sacrifices in magnetic flux density. The composite magnets including an interface material may have superior energy product than magnets without an interface material.

The incorporation of interface/transition layers also reduces expense because it reduces the amount of more expensive permanent magnet materials that are needed. The magnets described herein may be used in any suitable application such as in an electric machine. For example, the composite magnets described herein may be used in the stator or rotor of an electric machine such as the power system of a vehicle (e.g., automobile, motorcycle, aircraft, watercraft, and locomotive).

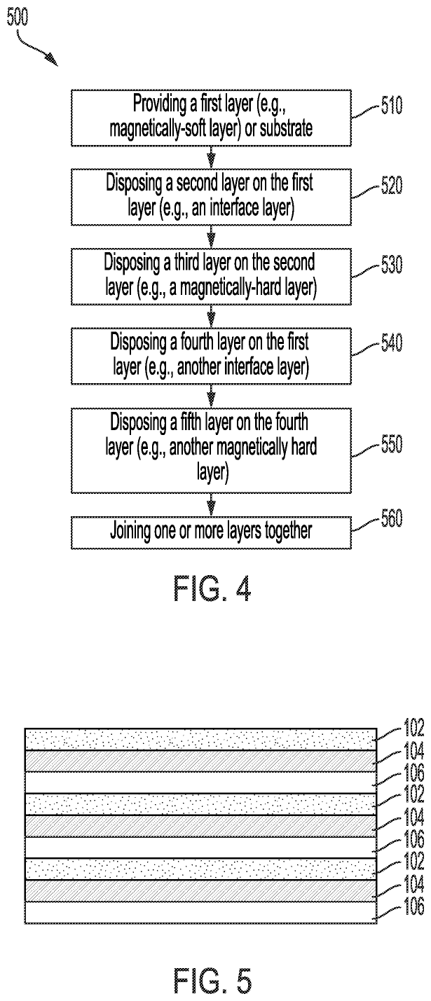

Referring to FIG. 4, a method 500 of making a composite magnet is disclosed. The method includes providing a first layer (i.e., step 510) such as a magnetically-soft layer (e.g., iron or iron cobalt sheet). The first layer may be a prefabricated sheet or film. In a refinement, the first layer may be applied to a substrate. A second layer (i.e., step 520) such as an interface layer may be disposed on a first side of the first layer and a third layer (i.e., step 530) such as a magnetically-hard layer may be disposed on the second layer opposite the first layer. In a variation, a fourth layer such as an interface layer may be disposed on the second side of the first layer opposite the second layer (i.e., step 540) and a fifth layer such as a magnetically-hard layer may be disposed on the fourth layer opposite the second layer (i.e., step 550). Additionally, magnetically-soft layers, for example, may be applied to the third and fifth layers and the process may be repeated until the desired size of the composite magnet is achieved. The layers may be applied as sheets or films such as prefabricated sheets or films. Alternatively, the layers may be applied as magnetic powder mixtures that are hot-compacted. In a refinement, the temperature and pressure may be sufficient to achieve an average grain size of at least 3 μm, or more preferably at least 1 μm, or even more preferably at least 0.5 μm, or still even more preferably at least 0.25 μm. For example, the layers may be heated and pressed for sintering. at 400 to 700° C. or more preferably 500 to 600° C. The layers may be joined by sintering or alternatively may be joined by an adhesive such as an epoxy. In a refinement, the adhesive may be used for joining prefabricated sheets of each material having generally flat surfaces. Very little adhesive may be needed or remain in the composite magnet when the prefabricated layers have generally flat surfaces which may reduce interference or reduce loss of magnetic properties. In other words, each layer may be joined to the adjacent layer (i.e., step 560). In one or more embodiments, all the layers may be provided as powders or all the layers may be provided as sheets such that manufacturing is uniform. In yet another embodiment, the various layers may be disposed and/or joined by additive manufacturing techniques such as laser melting. In a refinement, selective laser melting, direct laser melting, direct metal laser melting, or powder bed fusion may be used.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A composite magnet comprising:
a plurality of permanent magnet regions;
a plurality of non-permanent magnet regions; and
a plurality of interface regions disposed between each of the permanent magnet regions and the non-permanent magnet regions, wherein the interface regions have a coercivity of 5-1500 kiloampere per meter and are different than the permanent and non-permanent magnet regions.

2. The composite magnet of claim 1, wherein the permanent magnet regions have a thickness of at least 100 nanometers.

3. The composite magnet of claim 2, wherein the thickness is at least 250 nanometers.

4. The composite magnet of claim 1, wherein the plurality of permanent magnet regions are permanent magnet layers, the plurality of non-permanent magnet regions are non-permanent layers, and the plurality of interface regions are interface layers.

5. The composite magnet of claim 1, wherein the plurality of interface regions has a coercivity between that of the plurality of permanent magnet regions and the non-permanent magnet regions.

6. The composite magnet of claim 1, wherein the plurality of interface regions each have a saturation magnetization that is between that of the plurality of permanent magnet regions and the plurality of non-permanent magnet regions.

7. The composite magnet of claim 1, wherein the plurality of interface regions include a lower grade permanent magnet, Al—Ni—Co, Fe—N, Mn—Al, Mn—Al—C, and/or Mn—Bi.

8. A composite magnet comprising:
a magnetically-hard portion;
a magnetically-soft portion; and
an interface portion disposed between the magnetically-hard portion and the magnetically-soft portion, the interface portion including a lower grade magnetically-hard material than the magnetically-hard portion or a magnetically semi-hard material such that it is different than the magnetically-hard portion and the magnetically-soft portion.

9. The composite magnet of claim 8, wherein the interface portion has a coercivity between the magnetically-hard portion and the magnetically-soft portion.

10. The composite magnet of claim 9, wherein the magnetically-hard portion has a higher coercivity than the magnetically-soft portion.

11. The composite magnet of claim 8, wherein the interface portion includes a lower grade permanent magnet, Al—Ni—Co, Fe—N, Mn—Al, Mn—Al—C, Mn—Bi and/or a magnetic material having an L1₀ structure.

12. The composite magnet of claim 11, wherein the magnetically-hard portion includes Nd—Fe—B and/or Sm—Co and the magnetically-soft portion includes Fe and/or Fe—Co.

13. An electric machine comprising a rotor and/or stator including the composite magnet of claim 8.

14. A vehicle comprising a power system including the electric machine of claim 13.

15. A method of manufacturing a magnet comprising:
disposing a first interface layer on a first magnetically-soft layer;
disposing a first magnetically-hard layer on the first interface layer opposite the first magnetically-soft layer; and
joining the layers together to form a composite magnet.

16. The method of claim 15, further comprising:
disposing a second interface layer on the first magnetically-soft layer opposite the first interface layer, and disposing a second magnetically-hard layer on the second interface layer opposite the first magnetically-soft layer.

17. The method of claim 15, wherein the first interface layer has a coercivity that is between that of the first magnetically-hard layer and the first magnetically-soft layer.

18. The method of claim 17, wherein the coercivity of the first interface layer is 20-800 kiloampere per meter.

19. The method of claim 17, wherein the first interface layer includes a lower grade permanent magnet material, Al—Ni—Co, Fe—N, Mn—Al, Mn—Al—C, Mn—Bi and/or a magnetic material having an L1₀ structure.

20. The method of claim 15, wherein each layer has a thickness of at least 0.5 micrometers.
